(19) United States
(12) Patent Application Publication
(10) Pub. No.: US 2013/0086615 A1
(43) Pub. Date: Apr. 4, 2013

(54) CONCURRENT REAL-TIME COMMUNICATION WITH MEDIA CONTEXTUALIZED ACTIVITY SHARING

(71) Applicants: Robert Williams, San Francisco, CA (US); Robert Glaser, Seattle, WA (US); Richard Stern, Oakland, CA (US); Jeff McLeman, Issaquah, WA (US); Cody Bittle, Sunnyvale, CA (US); Ryan Chase, San Francisco, CA (US)

(72) Inventors: Robert Williams, San Francisco, CA (US); Robert Glaser, Seattle, WA (US); Richard Stern, Oakland, CA (US); Jeff McLeman, Issaquah, WA (US); Cody Bittle, Sunnyvale, CA (US); Ryan Chase, San Francisco, CA (US)

(73) Assignee: SocialEyes, Inc., San Francisco, CA (US)

(21) Appl. No.: 13/279,218

(22) Filed: Oct. 21, 2011

Related U.S. Application Data
(60) Provisional application No. 61/542,674, filed on Oct. 3, 2011.

(51) Int. Cl. H04M 1/64; H04L 12/16; H04N 7/16; H04W 24/00; H04M 11/00; H04W 4/12

(52) U.S. Cl. 725/62; 379/93.01; 455/466; 455/456.1; 379/88.12; 370/271

(57) ABSTRACT

Extensible media and/or activity sharing within a voice call or concurrent real-time communication session is enabled. A concurrent voice call may contextualize shared media and/or activities. Users may share live experiences within the context of a voice call. Continuous, changing real-time media types such as periodic media (e.g., a user's current location) and streaming media (e.g., what the user is currently “seeing” through their personal video camera) may be shared, as well as interactive activities and atomic media types such as an image or a text message. Such sharing may have a unidirectional modality, for example, one party may offer to share media and/or an activity and another party may accept or reject it. Once accepted, the media and/or activity may be available until the sharing party terminates the call or ends the sharing. Conventional mobile computing environments may be adapted to enable rapid, wide-spread adoption of these communication modalities.

### CROSS-REFERENCES TO RELATED APPLICATIONS

This application claims the benefit of U.S. Provisional Application No. 61/542,674, filed Oct. 3, 2011, titled “Synchronous Real-time Communication With Media Contextualized Activity Sharing,” and having Attorney Docket No. 93795-821924 (000200US), the contents of which is hereby incorporated in its entirety by reference.

### FIELD OF THE INVENTION

This invention pertains generally to communication and, more particularly, to computer-facilitated communication.

### BACKGROUND

The use of mobile phones to share multimedia such as photos, videos, text, and location co-ordinates over cellular and Wi-Fi data networks has become common. While the adoption of data-oriented services has grown, voice calling is still the most popular use case for mobile phones. However, challenges related to operating systems, handset hardware and network limitations have contributed to keeping voice and data service largely separate and uncoupled. The user experience can be confusing, frustrating and/or inefficient. Effective communication between users can be compromised. Conventional attempts to address these issues are flawed.

For example, some conventional systems require users to instantiate each data sharing service independently of a voice call and independently identify one or more sharing participants. A particular set of installed applications may be required. One or more of the sharing participants may not be able to receive data simultaneously with voice, and it may be difficult to determine if this is the case in advance. Some conventional systems provide for a type of non-real-time or delayed sharing, but delays can be significant, flawing and even disrupting a conversation. Some conventional systems provide insufficient access to communication device components and/or are inflexible with respect to communication device resource allocation between voice and data aspects of a communication session. Some conventional systems and methods fail to provide a user interface and/or protocol that facilitates effective communication with voice and multiple data-based sharing activities and/or that is extensible, for example, with respect to new data-based sharing activities.

Some conventional systems require relatively high levels of computational resources. This can be particularly problematic in resource-constrained environments such as mobile computing environments and other power-constrained environments. Some conventional systems create an expectation of, or even enforce, socially awkward communication behaviors, situations, protocols and/or idioms (collectively “communication scenarios”). Communication scenarios that are appropriate for formalized communications can be inappropriate and/or ineffective for casual, spontaneous and/or ad hoc communication (collectively, “casual communication”). Some conventional systems require custom and/or specialized hardware, which can impose constraints on wide-spread adoption. Such conventional systems can be richly featured yet of limited utility due to a relatively low number of potential communication participants.

Embodiments of the invention are directed toward solving these and other problems individually and collectively.

### SUMMARY

As part of real-time communication between users of communication devices, a communication connection may be established between the communication devices in accordance with a telephony protocol. A voice call may be maintained over the communication connection. During the voice call, media may be captured by one of the communication devices and unidirectionally streamed to another of the communication devices. For example, the media may include video. During the streaming of the media, one or more communicative activities may be provided that are concurrent with and contextualized by the streaming media. Such communication may be facilitated by one or more components incorporated into communication devices and/or computing devices.

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

### BRIEF DESCRIPTION OF THE DRAWINGS

Illustrative embodiments of the present invention are described in detail below with reference to the following drawing figures:

FIG. 1 is a schematic diagram depicting aspects of an example computing environment in accordance with at least one embodiment of the invention;

FIG. 2 is a schematic diagram depicting aspects of an example communication client in accordance with at least one embodiment of the invention;

FIG. 3 is a schematic diagram depicting aspects of an example communication server in accordance with at least one embodiment of the invention;

FIG. 4 is a schematic diagram depicting further aspects of an example communication client in accordance with at least one embodiment of the invention;

FIG. 5 is a chart depicting aspects of an example contextualized communication scheme in accordance with at least one embodiment of the invention;

FIG. 6 is a schematic diagram depicting aspects of an example graphical user interface in accordance with at least one embodiment of the invention;

FIG. 7 is a schematic diagram depicting further aspects of example graphical user interfaces in accordance with at least one embodiment of the invention;

FIG. 8 is a flowchart depicting example steps for communication in accordance with at least one embodiment of the invention;

FIG. 9 is a flowchart depicting further example steps for communication in accordance with at least one embodiment of the invention;

FIG. 10 is a flowchart depicting still further example steps for communication in accordance with at least one embodiment of the invention;

FIG. 11 is a flowchart depicting example steps for instant replay of unicast streaming media in accordance with at least one embodiment of the invention; and

FIG. 12 is a schematic diagram depicting aspects of an example computer in accordance with some embodiments of the present invention.

Note that the same numbers are used throughout the disclosure and figures to reference like components and features.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

In accordance with at least one embodiment of the invention, extensible media and/or activity sharing within a voice call or concurrent real-time communication session is enabled. Real-time media and/or activities may be offered and shared within the context of a synchronous real-time communication, such as a phone call. One or more media types and/or user activities can be initiated, offered and shared either serially (during distinct time intervals) or concurrently (during a same time interval). A concurrent voice call may provide context for (may “contextualize”) shared media and/or activities. In accordance with at least one embodiment of the invention, a first communicative activity contextualizes a second communicative activity when the first communicative activity enhances, changes or modifies a meaning, connotation, cognitive association or content of the second communicative activity. Streaming media, such as audio and video, may contextualize shared activities and/or activity sharing. Such contextualization can significantly enhance communication ease, efficiency and/or effectiveness, as well as reducing user confusion and/or frustration.

In accordance with at least one embodiment of the invention, users may share live experiences within the context of a voice call. Continuous, changing real-time media types such as periodic media (e.g., a user's current location) and streaming media (e.g., what the user is currently “seeing” through their personal video camera) may be shared, as well as interactive activities and static or “atomic” media types such as an image or a text message. Different types of media (e.g., streaming, periodic and atomic) and/or activities may be shared with the context of a voice call. Such sharing may have a unidirectional modality, for example, one party may offer to share media and/or an activity and another party may accept or reject it. Once accepted, the media and/or activity may be available until the sharing party terminates the call or ends the sharing.

A voice call may terminate at a communication device that incorporates a media contextualized activity sharing component in accordance with at least one embodiment of the invention. Alternatively, or in addition, the voice call may terminate at a communication device that does not incorporate the media contextualized activity sharing component. In the later case, shared media and/or activities may be stored at an intermediate location (e.g., a network storage device) for later retrieval by the intended party, for example, when the intended party gains access to the media contextualized activity sharing component.

In accordance with at least one embodiment of the invention, the receiving party may independently manipulate shared media and/or activities while a voice call continues in real-time between the sending party and the receiving party. For example, the receiving party may pause or initiate an “instant replay” of video broadcast by the sending party before returning to “live” view.

In accordance with at least one embodiment of the invention, sharing of streaming media utilizing a unidirectional modality (e.g., “unicast” video) has multiple advantages. For example, computing device resource utilization may be reduced relative to sharing of streaming media using a bidirectional modality (e.g., conventional video “conferencing”). This can be a significant advantage in power-constrained computing environments. As another example, unidirectional modalities can enable socially graceful communication scenarios, particularly in a casual communication context. As yet another example, aspects of an available, deployed and/or installed mobile computing environment, such as the power-constrained, bandwidth-constrained, small-display computing environment of so-called “smart” phones (e.g., the Apple® iPhone®), may be relatively adaptable to unidirectional streaming media sharing modalities and user interfaces. This is not insignificant at least because such adaptability can enable rapid, wide-spread adoption of new communication modalities, thereby enhancing human communication.

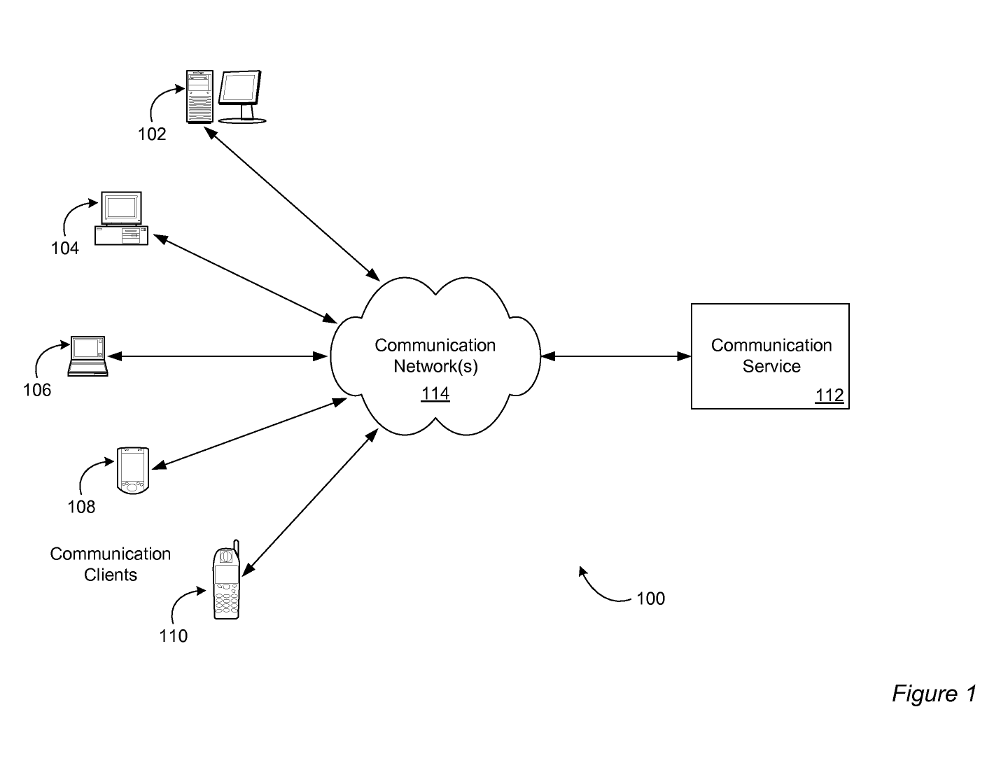

FIG. 1 depicts aspects of an example computing environment 100 in accordance with at least one embodiment of the invention. In the example computing environment 100, multiple communication clients 102-110 (and communication client types) may communicate with one another and with a communication service 112 through one or more communication networks 114. For example, the communication clients 102-110 may include mobile phones, cell phones, smart phones, mobile computing devices, personal digital assistants, tablet computers, personal computers, laptop computers, desktop computers, workstations, computers and computing devices. The communication network(s) 114 may incorporate, or be incorporated by, a telephonic network such as the public switched telephone network (PSTN), and a data network and/or internetwork such as a computer network, a public computer network, the Internet, and an internet protocol (IP) based network. The communication network(s) 114 may include any suitable networking components including wired and wireless components, switches, routers, hubs, computers and computing devices.

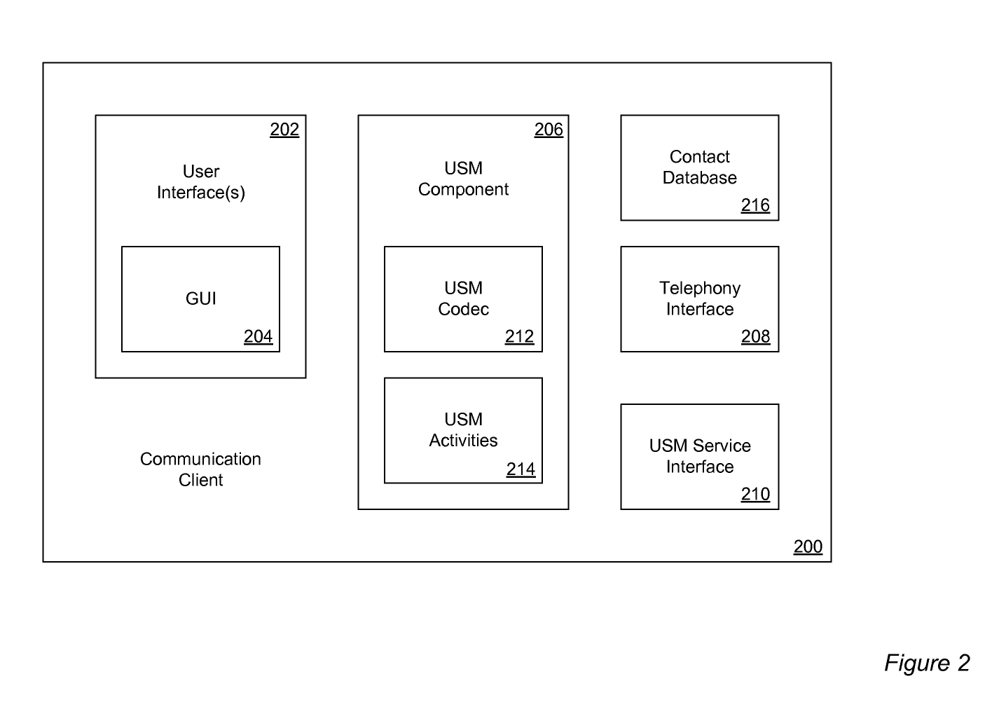

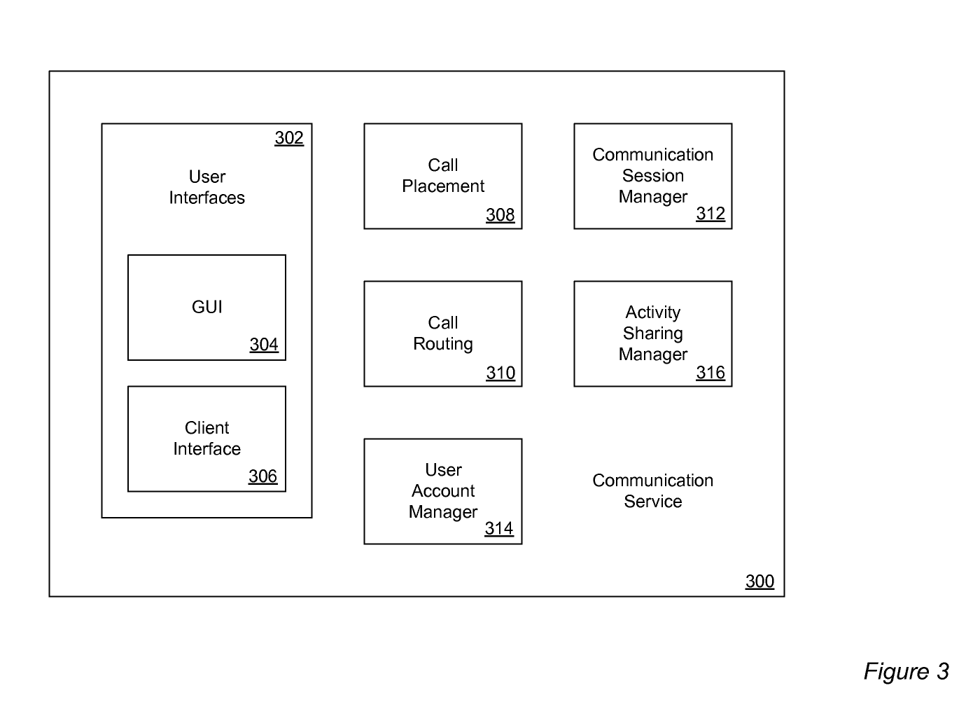

One or more of the communication clients 102-110 may include one or more media contextualized activity sharing components in accordance with at least one embodiment of the invention. FIG. 2 depicts aspects of an example communication client 200 in accordance with at least one embodiment of the invention. The communication client 200 of FIG. 2 is an example of the communication clients 102-110 of FIG. 1. The example communication client 200 includes one or more user interfaces 202 such as a graphical user interface (GUI) 204, a unicast streaming media (USM) component 206, a telephony interface 208 and a USM service interface 210. Users may interact with the graphical user interface 204 to activate functionality of the USM component 206 and participate in a voice call with the telephony interface 208. The USM component 206 may interact with the USM service interface 210 to communicate with one or more USM components located at other communication clients 102-110 (FIG. 1). For example, such communication may be facilitated by the communication service 112 as described below in more detail with reference to FIG. 3. The USM component 206 may coordinate USM mode sharing through the USM service interface 210 with respect to voice calls that utilize the telephony interface 208.

In accordance with at least one embodiment of the invention, the USM component 206 facilitates a unicast streaming video mode at times herein called “see what I see” (SWIS) mode. Such a sharing mode may enable a receiving party to “see what I see” with a relatively simple user interface and/or with relatively efficient computing device resource usage, e.g., with respect to bandwidth and processing power. In accordance with at least one embodiment of the invention, recipients in such a sharing mode may initiate an “instant replay” of streamed media while the audio call continues in real-time. For example, streamed media may be stored in a data storage “buffer” (not shown in FIG. 2) that is limited in size and progressively over-written as new media arrives. Either the sending or receiving user can “skip back” through this window of stored streamed media to see what just happened. The user can later return to real-time video playback. Either party can also elect to permanently save the media after the fact rather than deciding to record the media in advance.

The USM component 206 may include a USM media encoder/decoder (codec) 212 optimized for SWIS mode media sharing and/or for a particular communication client (e.g., one of the communication clients 102-110 of FIG. 1). For example, some communication clients, and in particular some mobile communication clients, have limited computing resources and/or computing resources with restricted availability and/or restricted flexibility with respect to resource allocation, and the USM codec may adapt to the limitations and/or restrictions of the particular communication client to optimize the SWIS mode media sharing user experience. Where the communication client does not make streaming media facilitates available to installable components such as the USM component 206, the USM codec 212 may adapt and/or re-purpose communication client components such as hardware components, operating system components and programmatic interfaces such as application programming interfaces (APIs) to enable unicast streaming media.

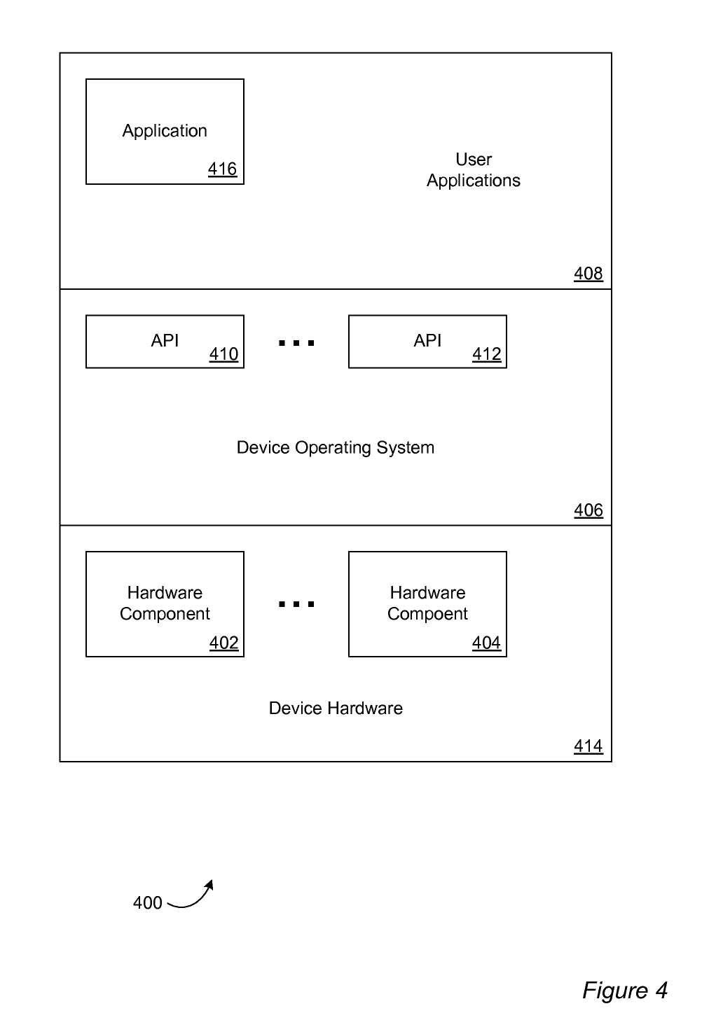

For example, suppose the communication client 108 of FIG. 1 is generally “shipped” (e.g., distributed to the public) with a basic ability to capture video to file in a standard format. The USM codec may establish and maintain a set of video-capturing programmatic objects that write to a set of files. The video capturing objects and files may be coordinated so that the set of files is organized into an array that can be processed (e.g., formatted) to create a video stream. Example details in accordance with at least one embodiment of the invention are described below in more detail with reference to FIG. 4.

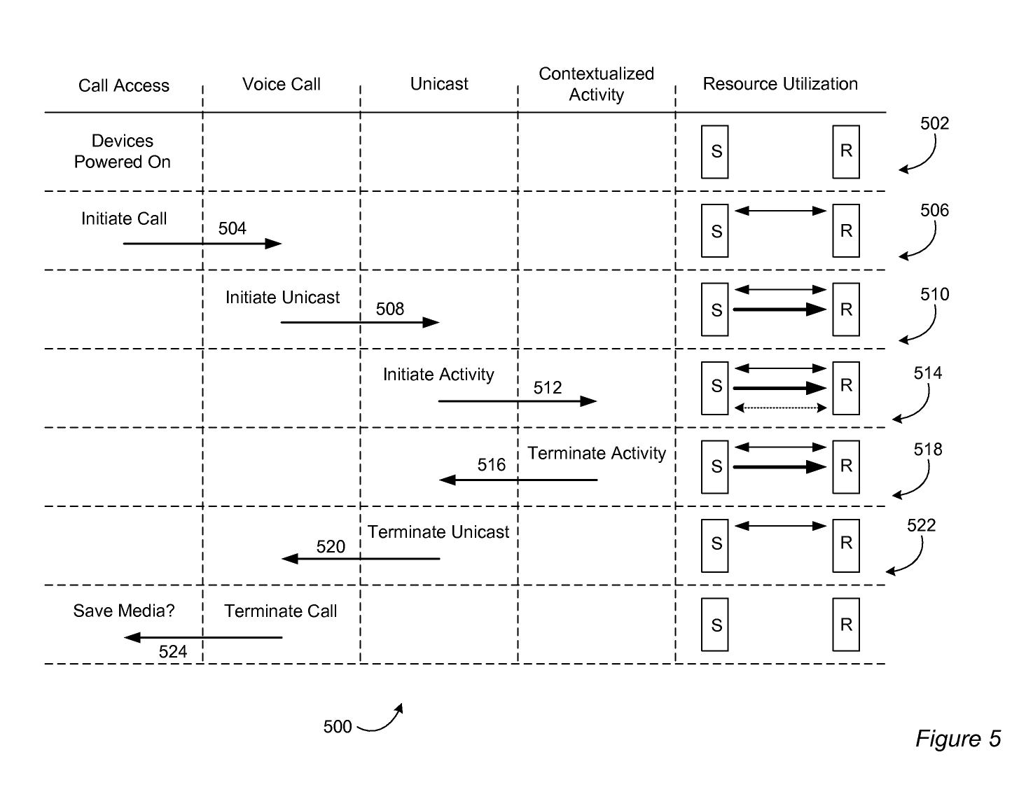

The USM component 206 may further include a USM activities component 214 configured at least to facilitate media contextualized activity sharing. For example, during SWIS mode, users may offer, accept and/or reject a variety of sharing activities such as media annotation including freehand touch-based drawing and text captioning, contextualized messaging including text messaging and rich media messaging, sharing of contacts from a contact database 216 maintained by the communication client 200, media processing including object recognition and visual code (e.g., QR code) recognition, web link sharing including sharing of web links associated with object and code recognitions, concurrent browsing (“co-browsing”) of shared web links and communication client sensor data sharing including sharing of geographic location data. Such sharing activities may be initiated and terminated independent of SWIS mode with one of the user interfaces including the graphical user interface and/or physical user interface components of the communication client including buttons and motion sensors such as sensors that detect device “shaking.” Example details in accordance with at least one embodiment of the invention are described below in more detail with reference to FIG. 5.

FIG. 3 depicts aspects of an example communication service 300 in accordance with at least one embodiment of the invention. The communication service 300 of FIG. 3 is an example of the communication service 112 of FIG. 1. The example communication service 300 includes user interfaces 302 including a graphical user interface (GUI) 304 such as a web-based GUI, and a client interface 306. The client interface 306 enables the communication client 200 to access functionality of the communication service 300 such as user account management, call placement, call routing, communication session management and activity sharing management.

For example, an address book of a user's contacts (e.g., maintained by the user's communication client 200 of FIG. 2) may allow the user to select a contact to call. The interface 306 allows the user to place calls to any number. If the number is registered in the system (e.g., with the call placement component 308) then a call may be placed via IP to the client associated with that number (e.g., one of the communication clients 102-110). If the contacted client is offline (e.g., in a low-power mode), a push message may be sent to the device associated with the client to prompt the called party to start their client and answer the incoming call. If the number is not associated with a registered client in the system then the call may be routed to a standard telephony network via an IP to PSTN server (e.g., with the call routing component 310). For example, the communication service 300 may provide client presence and messaging functionality in accordance with an extensible messaging and presence protocol (e.g., XMPP) and telephony functionality in accordance with a session initiation protocol (e.g., SIP as described in RFC 3261).

Two communication clients may be able to connect in a variety of ways. For example, one communication path between the two clients may be through the PSTN, at least in part. Another communication path between the two clients may lay entirely in an IP-based network. Where multiple communication paths exists, one may be preferred or “default”. For example, a lowest cost communication path may be preferred or a type of communication path, such as an all IP-based communication path, may be preferred. Alternatively, or in addition, a set of communication path choices may be presented to a user for selection. In the case that the contacted client is offline, and a push message is sent through one communication path, contact may be attempted with an alternate communication path. For example, if a user does not respond to a notification sent through an IP-based communication path, a call may be placed through the PSTN. This example has the advantage that the call may terminate in the recipient's conventional voicemail box if the recipient does not answer the call. In the case that multiple contact locations (e.g., telephone numbers) are associated with a particular contact, the calling client may attempt contact at each contact location in a default or specified order, and may select an appropriate communication path (or sequence of communication paths) based at least in part on each contact location. Alternatively, or in addition, a set of contact location choices may be presented to a user for selection.

Once a client to client connection has been established, a session management layer operating over the server-routed messaging layer (e.g., maintained by a communication session manager 312) may be used to establish a bi-directional client to client voice channel, for example, in accordance with Internet Engineering Taskforce (IETF) XMPP, Jingle (XEP-0166), ICE (RFC 5245) and STUN (RFC 5389) standards, as appropriate. A client to client video channel may be negotiated (e.g., with respect to codec format and bit rate) at the same time as the voice channel is negotiated, although not necessarily utilized until later in a communication session.

In accordance with at least one embodiment of the invention, an extensible layer for negotiating activities and media sharing over the messaging layer is provided. For example, this may be implemented in accordance with an XMPP over a conventional text messaging channel by using a custom type attribute or globally unique identifier (GUID), for example based on location, to identify the packet as belonging to a specific activity type. Alternatively, or in addition, a namespace-extensible scheme can be utilized to allow third party activities to be added and the information to be routed to the appropriate system component.

Within messaging packets, an object description language such as “JAVASCRIPT” object notation (JSON) may be utilized to specify serialized data interchanged between clients. For example, a location object may be specified as follows:

```
  {
    ″longitude″ : −122.0777666163481,
    ″latitude″ : 47.55161643400493,
    ″jid″ : ″14256544929@xmpp.socialeyes.com″,
    ″description″ : ″my location″,
    ″timestamp″ : 12312312312312
  }
```

where “longitude” and “latitude” correspond to geographic coordinates of the messaging originator, “jid” corresponds to a GUID for the data object, “description” is a plain text, human readable description of the data object, and “timestamp” corresponds to a date and time specification (e.g., a number of microseconds since the year 1900).

Different types of data may be handled differently. For example, with respect to atomic units of small data, small objects such as a location can be sent via the messaging channel as described above. With respect to periodic units of small data, some data types such as a location track can be sent as atomic units of small data but may be preceded or ended by a “starting to share” message sent via the same messaging channel. With respect to large data objects, larger data objects such as a picture, saved video, file, or VCard may be transmitted by uploading the object to cloud based storage (e.g., through the communication server and/or an associated web service) and then having the web service inform the other client that the object is available for retrieval. This also allows these larger objects to be persisted indefinitely in the case that they are not able to be retrieved immediately. With respect to streaming video or other streaming media, control messages may be sent via the messaging channel to offer video from one party to the other and to either accept or reject streaming video. In accordance with at least one embodiment of the invention, video streams may correspond to uni-directional offers (for example, a person might offer to show the other person in the call what they are seeing right now) rather than a bi-directional session. In accordance with at least one embodiment of the invention, this does not prevent both parties from offering to share video in a socially graceful communication scenario.

User account management functionality, such as creating, access, updating and deleting user account information including user preferences, as well as user authentication and service configuration including service billing and related functionality, may be provided by a user account manager component 314. Activity sharing functionality, such as processing activity sharing protocol messages, as well as enabling immediate and/or delayed access to media related to shared activities may be provided by an activity sharing manager component 316.

As described above, the USM codec 212 (FIG. 2) may adapt and/o re-purpose communication client 200 components to enable communication in accordance with at least one embodiment of the invention. FIG. 4 depicts further aspects of an example communication client 400 in accordance with at least one embodiment of the invention. The communication client 400 of FIG. 4 is an example of the communication client 200 of FIG. 2. The communication client 400 may include a set of device hardware components 402-404 managed by an operating system 406. User applications 408 may access functionality provided by the hardware components through components of the operating system 406 such as application programming interfaces (APIs) 410-412. In this example, user applications 408 are applications that are installable by an end-user of the communication client 400, in contrast to computing device applications such as the operating system 406 that are installed by a manufacturer of the communication client 400 and/or an operator of a communication network utilized by the communication client 400.

In accordance with at least one embodiment of the invention, the device hardware 414 corresponds to hardware of a mobile computing device. For example, the device hardware 414 may include one or more processors including central processing units (CPUs) and special-purpose processors such as telephony protocol processors and video encoding processors, one or more data storage components such as volatile and non-volatile data storage components including DRAM and “Flash” memory, one or more power sub-systems including a battery, as well as one or more network interfaces including wireless network interfaces and/or radios. In the case of mobile computing devices, access to device hardware 414 may be relatively strictly controlled by the operating system 406. For example, rather than providing applications 408 direct access to “device drivers” that in turn directly access the hardware components 402-404, applications 408 may be required to access the hardware components 402-404 indirectly through APIs 410-412 implementing relatively high-level functionality. There are good reasons for such restrictions. For example, “rogue” applications (e.g., applications incorporating incompetent or malicious programming) could otherwise rapidly drain the mobile device's battery of power and/or otherwise abuse the shared computing resources of the device (e.g., exceed a power budget of the application) and/or the communication networks 114 (FIG. 1) with which the device interacts. Nevertheless, such restrictions can be a barrier to innovative functionality.

In accordance with at least one embodiment of the invention, the hardware components 402-404 include a special-purpose media encoder 402 not directly accessible to user applications 408, however, the operating system 406 provides indirect access to the special-purpose media encoder through a media file writer programmatic object (“Writer object”), for example, incorporated into one of the APIs 410-412. While media may be encoded by appropriately configuring a general-purpose CPU using computer-executable instructions, this may be relatively power-inefficient. This is significant since a mobile computing device without power provides very little functionality at all. In contrast, the special-purpose media encoder 402 may perform its function in a relatively power-efficient manner. Accordingly, access to the encoder 402 utilizing Writer objects may be desirable, and even required for effective media streaming with respect to some mobile computing devices.

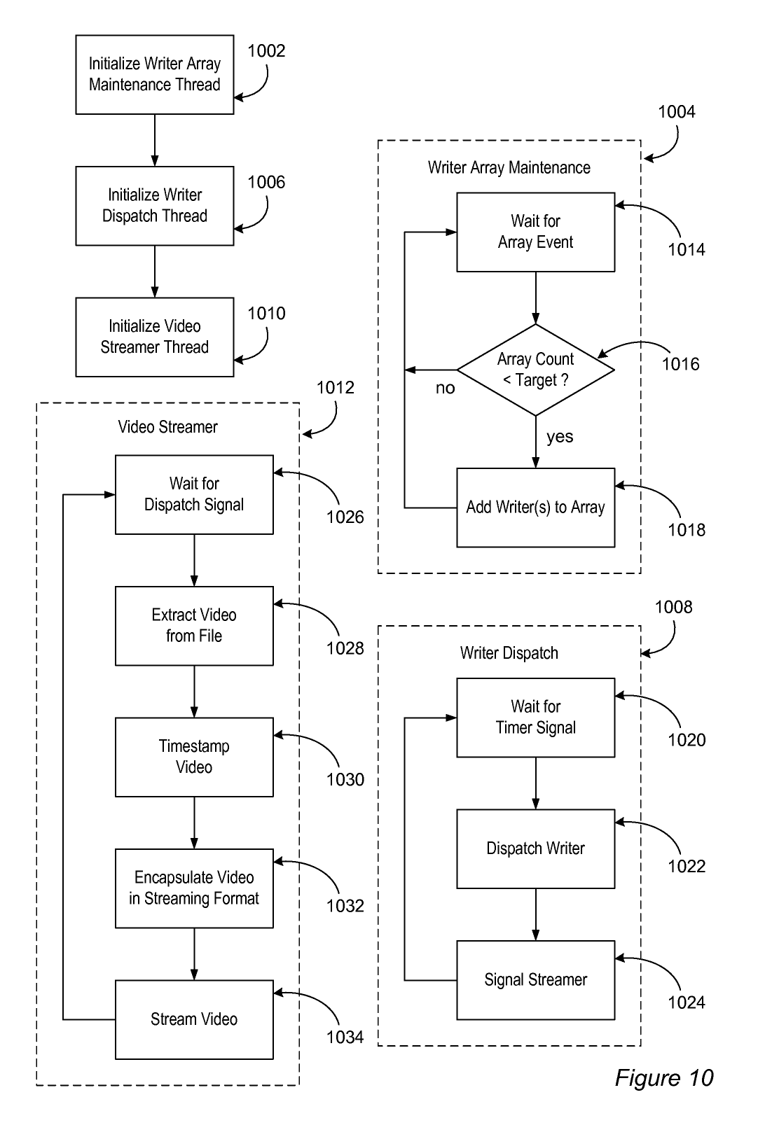

In accordance with at least one embodiment of the invention, an application 416 may incorporate and/or be incorporated by the communication client 200 (FIG. 2), and in particular may include the USM codec 212. The USM codec 212 may utilize Writer objects and APIs 410-412 of the operating system 406 to implement unicast streaming media in accordance with at least one embodiment of the invention. For example, the USM codec 212 may maintain an array of Writer objects, each of which may be directed to capture media (e.g., video and/or audio) to a file during a time interval using the encoder 402. The resulting files may be processed to generate a media stream. Example details are described below with reference to FIG. 10.

Power constraints can be significant when utilizing a mobile computing device to communicate. Another type of constraint includes user interface constraints. Mobile computing devices typically have a relatively small form factor and, accordingly, relatively small user interface components such as graphical displays. Utilization of such user interface resources can have a significant impact on the effectiveness and/or efficiency of communication with the mobile computing device. FIG. 5 depicts aspects of an example contextualized communication scheme 500 in accordance with an embodiment of the invention.

In a first mode of operation or user interface context 502, two mobile computing devices, an initiator or sender S and a responder or receiver R, are powered on, but not in communication, for example, through one of the networks 114 (FIG. 1). In this context, the sender S has “call access.” The sender S may decide to establish or initiate a voice call 504 with receiver R, for example, by selecting the receiver R from a contact list of the sender's mobile computing device. When the call is established, the mobile computing device of the sender S and the receiver R transition to a “voice call” mode of operation or user interface context 506. User interface resource constraints of the mobile computing devices typically mean that each such mode or context dominates the user interface resources. In the voice call context 506, the “resource utilization” column diagram shows a voice call connection between the sender S and the receiver R corresponding to a relatively modest utilization of the computing and bandwidth resources of the mobile computing devices.

In accordance with at least one embodiment of the invention, the sender S may initiate a streaming media unicast 508, such as a video unicast, to the receiver R. For example, the sender S may activate a user interface component (e.g., “swipe” an icon and/or slider component). Assuming the receiver R agrees to receive the unicast, the mobile computing device may transition to a streaming media unicast mode or context 510, in which, a media stream is generated, transmitted and presented at a user interface component of both the sender S and the receiver R. For example, the sender S may stream video captured in real-time, and the video may be concurrently presented (with respect to transmission system delays) at displays of the mobile computing devices of both the sender S and receiver R. The unicast context 510 may thus be a “see what I see” (SWIS) mode or context. The diagram in the resource utilization column indicates that a significant increase in utilization of computing and bandwidth resources may occur in this context 510. In at least one embodiment of the invention, this enhanced utilization is still less than conventional video conferencing as well as within the resource capacities of both mobile computing devices.

The streaming media unicast 510 is contextualized by the initial voice call 506. Alternatively, or in addition, the unicast 510 may contextualize further communicative activities. In accordance with at least one embodiment of the invention, the sender S and/or receiver R may initiate activities 512 that are contextualized by the streaming media 510, thereby entering a contextualized activity mode or context 514. For example, such activities may include streaming media annotations including text annotations and freehand drawing, concurrent text-based “chat” or “texting” functionality, sharing of still images captured from a video stream, automated recognition of objects in the video stream (e.g., recognition of objects, faces, text, codes such as QR codes) and triggered actions based on recognitions of sufficient confidence (e.g., accessing and/or transmitting information associated with a recognized QR code), as well as sharing of a current location or other information determined from data received by one or more sensors of the mobile computing device. The diagram in the resource utilization column shows further data being exchanged between the mobile computing devices in accordance with the contextualized activity.

Streaming media contextualized activities 514 may be transitory with respect to the streaming media context 510. Either party may terminate 516 the activity and return to the streaming media context 518. Similarly, the streaming media context may be transitory with respect to the voice call context 506. Again, either party may terminate 520 the unicast and return to the voice call context 522. At call termination 524, a both sender S and receiver R may decide whether to save or store the streaming media that was unicast and/or media associated with the contextualized activities. In at least one embodiment of the invention, the “tiered” nature of the contextualized communication scheme 500 provides an efficient, effective and/or enhanced mode of communication between the sender S and the receiver R that respects the constraints of the associated mobile computing devices.

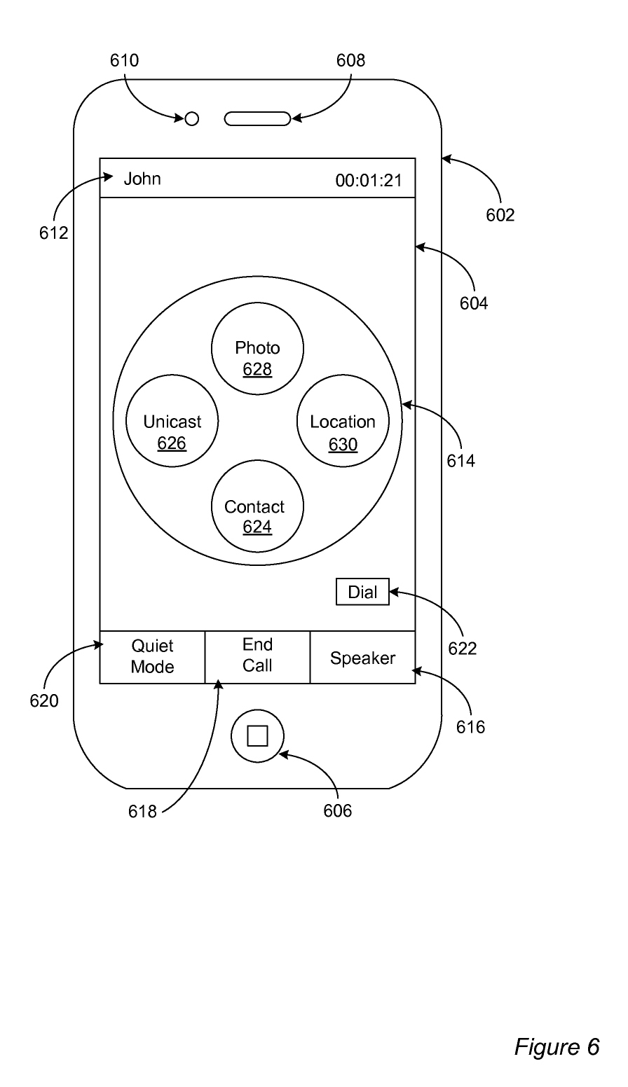

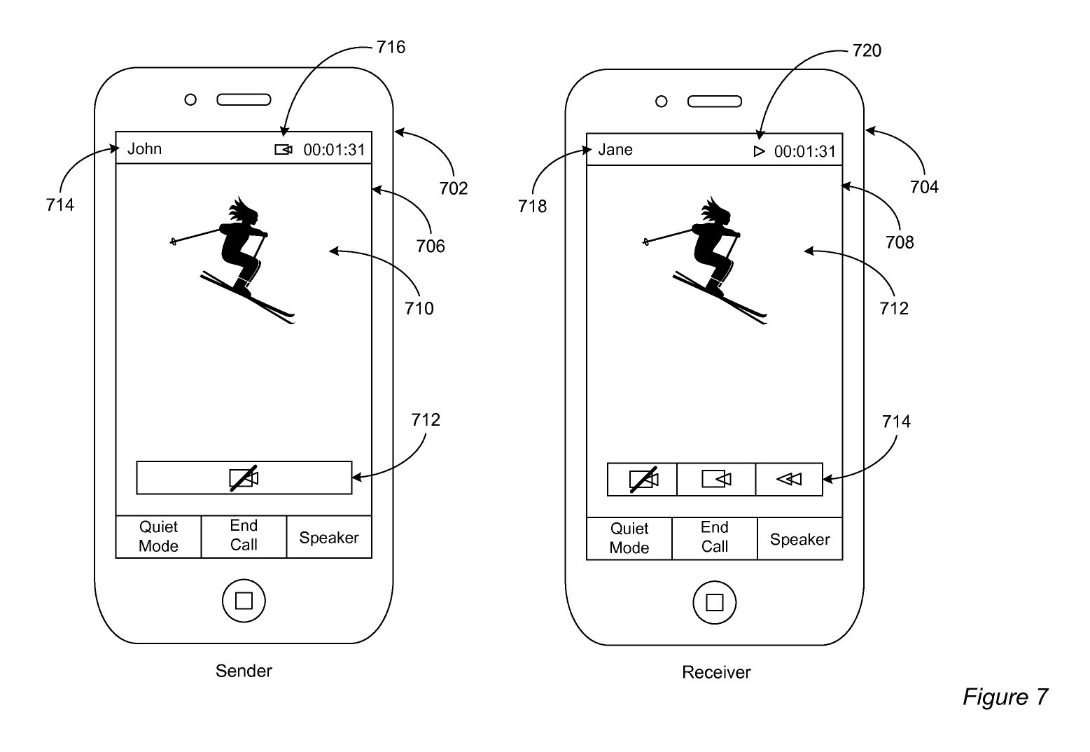

FIG. 6 and FIG. 7 depict aspects of example graphical user interfaces (GUIs) in accordance with at least one embodiment of the invention. The example GUIs depicted in FIG. 6 and FIG. 7 may be incorporated into one or more of the user interface contexts depicted in FIG. 5. A communication device 602 may have one or more display surfaces each capable of displaying graphics and/or one or more visual indications. The communication device 602 may have a main display surface 604 that is, for example, larger than other display surfaces. The display surface 604 may be a touch screen that provides for touch-based input. The communication device 602 may include one or more physical user interface elements such as a home button 606, and a variety of sensors and transducers such as a speaker 608, a microphone (not shown in FIG. 6), an ambient light sensor 610 and an accelerometer (not shown in FIG. 6). The display surface 604 may present a graphical user interface having a plurality of interface elements including a status display region 612, an in-call activity dial 614, a speaker button 616, an end call button 618, a quiet mode button 620 and a switch to number pad button 622. The in-call activity dial 614 may include a plurality of interface elements, such as a contact button 624, a unicast streaming media button 626, a photo button 628, and a location button 630, shaped and arranged to evoke recognition of a rotary dial user interface.

As depicted in FIG. 6, the status display region 612 may display an identifier of one or more recipients of a voice call as well as an elapsed call time. User interaction with the speaker button 616 may put the communication device 602 into an enhanced audio output mode. User interaction with the end call button 618 may terminate the current voice call. User interaction with the quiet mode button 620 may put the communication device 620 into a reduced audio output mode and/or temporarily mute audio associated with a current voice call without ending the call. In accordance with at least one embodiment of the invention, user interaction with the quiet mode button 620 causes a set of user interface elements to be displayed (not shown in FIG. 6) that enable sending of a text message associated with the quite mode, for example, explaining a reason for activating quite mode. A switch to number pad button 622 may replace the in-call activity dial 614 with a conventional number pad such as that used for dialing telephone numbers.

User interaction with the contact button 624 of the in-call activity dial 614 may enable addition of (or switch to) a new call participant. User interaction with the unicast streaming media button 626 may initiate unidirectional streaming of media captured by a camera (not shown in FIG. 6) of the communication device 602. For example, user interaction with the unicast streaming media button 626 may initiate a transition from the voice call context 506 of FIG. 5 to the unicast streaming media context 510 and/or to the graphical user interface depicted in FIG. 7. User interaction with the photo button 628 may enable sending of an image captured by a camera of the communication device 602 to recipients of the current voice call. User interaction with the location button 630 may enable sending of a geographical location of the communication device 602 to recipients of the current voice call.

FIG. 7 depicts example graphical user interfaces associated with a sending communication device 702 and a receiving communication device 704 of unicast streaming media in accordance with at least one embodiment of the invention. The communication devices 702 and 704 of FIG. 7 may have features corresponding to features of the communication device 602 of FIG. 6. Following activation of unicast streaming mode, display surfaces 706 and 708 of the sending and receiving communication devices 702 and 704 may display a rendering of the unicast streaming media. For example, the GUIs of the communication devices 702, 704 may include interface elements 710, 712 capable of presenting video based at least in part on the unicast streaming media. A status bar 714 of the sender 702 may include an indication 716 (e.g., a visual indication) that the sender 702 is currently streaming media captured by the communication device 702. A status bar 718 of the receiver 704 may include an indication 720 (e.g., a visual indication) that the receiver 704 is current receiving media streamed from the communication device 702.

The GUI of the sender 702 may include a unicast streaming media activity menu 712. The unicast streaming media activity menu 712 may be transient and/or translucent. For example, the menu 712 may become visible and/or fully visible responsive to touching the display surface 706. The unicast streaming media activity menu 712 of the sender 702 may include a stop unicast button (as depicted in FIG. 7) for terminating the unicast being streamed from the sender 702. The GUI of the receiver 704 may include a corresponding unicast streaming media activity menu 714. As depicted, the number and/or type of buttons and/or sub-elements may vary to present relevant and/or most relevant unicast streaming media activities, including those not shown in FIG. 7. The unicast streaming media activity menu 712 of the receiver 704 may include a stop unicast button for terminating participation in the unicast being received by the receiver 704, a start unicast button for initiating a new unicast of streaming media from the receiver 704 (at which time it would become a sender), and a unicast streaming media instant replay button for replaying a portion of the unicast (e.g., a most recent and/or “buffered” portion). Received text messages may be display concurrent with (e.g., superimposed over) the streamed media 710, 712.

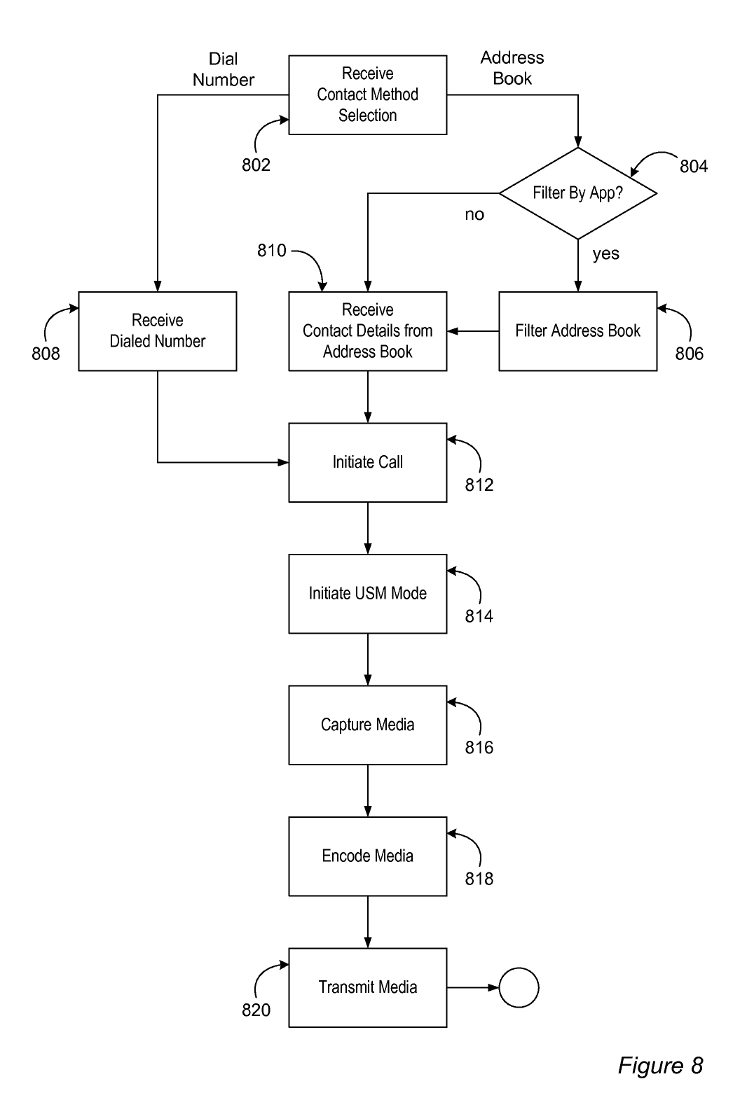

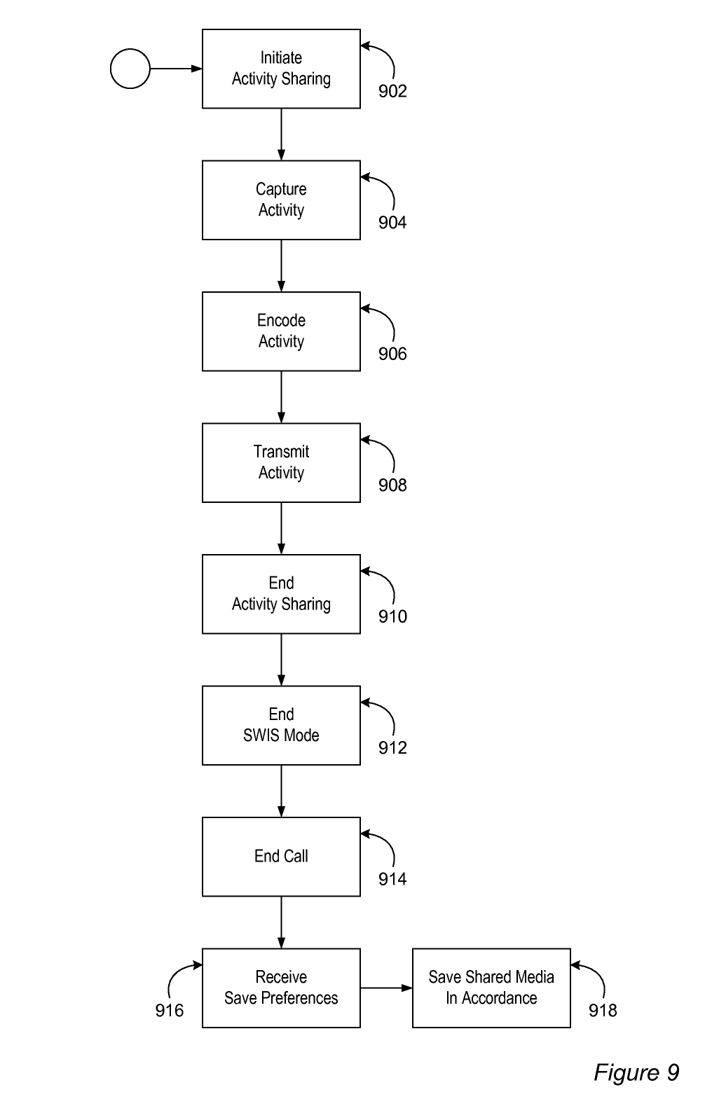

FIG. 8 and FIG. 9 depict example steps for communication in accordance with at least one embodiment of the invention. The communication client 200 (FIG. 2) may receive a contact selection method (step 802). For example, a user may opt to dial a contact number or access an address book of contacts. It may be that only some subset of the user's contacts have a communication device incorporating a media contextualized activity sharing component (e.g., a corresponding application or “app” installed where the communication device is capable of installing such applications), and the user may opt (step 804) to filter (step 806) the address book on that basis. In any case, the communication device may receive the dialed number (step 808) and/or selected contact details (step 810) and initiate a voice call (step 812).

At some later time, the user may interact with the communication client to initiate USM mode (step 814), for example, using the GUI. In response, the communication client may capture (step 816) and encode (step 818) media, for example, with the USM codec 212 (FIG. 2), and transmit (step 820) the resulting stream to the recipient, for example, through the communication service 300 (FIG. 3). The recipient has the option of declining to receive the streamed media and/or opting to have it stored for later access (steps not shown in FIG. 8).

While USM mode is active, a participant may further initiate activity sharing (step 902) that is contextualized by the streamed media. For example, the USM activities component 214 (FIG. 2) may facilitate capture (step 904), encoding (step 906) and transmission (step 908) of such activities. Such activities, USM mode and the call may be independently terminated (steps 910, 912 and 914, respectively). Following the call, participants may be given the option of storing shared media, including shared activities, for later access. Accordingly, the respective communication devices may receive corresponding “save” preferences (step 916) and cause the indicated shared media to be stored in accordance (step 918), for example, stored by the communication service 300 (FIG. 3).

The USM codec 212 (FIG. 2) may be implemented, at least in part, with computer-executable instructions that instantiate and manage multiple threads of execution (e.g., with “multithreaded” program code). FIG. 10 depicts example steps that may be performed by the USM codec 212 in accordance with at least one embodiment of the invention. As described above with reference to FIG. 4, the USM codec 212 may utilize Writer objects to access the encoder 402. At step 1002, a Writer array maintenance thread 1004 may be initialized. At step 1006, a Writer dispatch thread 1008 may be initialized. At step 1010, a video streamer thread 1012 may be initialized. These threads of execution 1004, 1008, 1012 have interdependencies, but allow some independent and/or parallel processing to occur.

The Writer array maintenance thread 1004 may wait for an array event (step 1014). Example array events include initialization, array object dispatch, and/or a periodically generated timing signal. Responsive to array event occurrence, it may be determined (step 1016) whether a number of Writer objects in a Writer array is less than a target number (e.g., 10). If so, the thread 1004 may progress to step 1018 to instantiate and add one or more Writer objects to the array. Otherwise, the thread 1004 may return to step 1014 to wait for a next array event.

The Writer dispatch thread 1008 may wait for a timer signal (step 1020). For example, such a signal may be generated every second. Responsive to receiving the timer signal, a Writer object in the Writer array may be dispatched (step 1022). For example, a currently active and/or oldest Writer object in the Writer array may be signaled (e.g., with a Writer object API call) to finish capturing video to a file and to make the file ready for further processing (e.g., to “close” the file). At step 1024, the Writer dispatch thread 1008 may signal the video streamer thread 1012 that the file is ready for further processing. The thread 1008 may then return to step 1020 to wait for the next timer signal.

The video streamer thread 1012 way wait for dispatch signals (step 1026) such as signals from the writer dispatch thread 1008. Responsive to receipt of such signals, the video streamer thread 1012 may extract streaming media from the file created by a Writer object (step 1028). For example, the file may be in QuickTime® format, and the USM codec 212 (FIG. 2) may extract video from the file. At step 1030, the video streamer thread 1012 may “timestamp” the extracted video with respect to a current USM mode or context 510 (FIG. 5). Alternatively, or in addition, the video streamer thread 1012 may maintain a video frame count with respect to the current USM context. For example, each file generated by Writer objects may include video frame counts, but the video frame counts may begin with one (or zero) in each file. Simply forwarding these frame counts to the communication service 114 (FIG. 1) could result in a corrupted media stream since, in the context of the unicast as a whole, the counts could be non-monotonic. At step 1032, the resultant video may be formatted in accordance with a suitable media streaming format. At step 1034, the formatted video may be streamed to the communication service 114 and/or to its intended recipient.

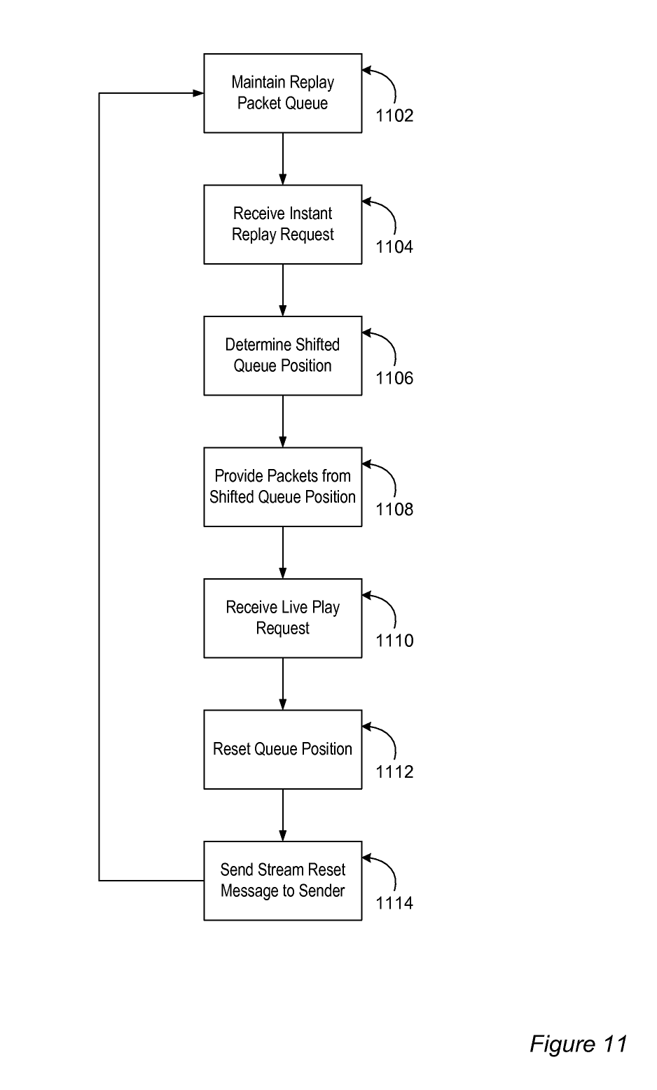

FIG. 11 depicts example steps for instant replay of unicast streaming media in accordance with an embodiment of the invention. A replay queue of received streaming media packets may be maintained (step 1102). In accordance with at least one embodiment of the invention, packets are stored for possible instant replay before decoding in order to reduce memory utilization. Decoded and/or uncompressed frames of streaming media such as video frames may be relatively large. As each packet is received (e.g., from the Sender S), it may be time stamped and pushed on the front of the queue. The replay queue may be maintained, at least in part, by examining the oldest packets in the queue to determine if the timestamp of the oldest packet in the queue is greater than a threshold amount of replay time. If it is older, then the packet may be removed from the back of the queue and the associated memory released. This processes may be repeated until the queue only contains packets that are newer than the specified threshold. Such maintenance may be performed whenever a packet is received. In normal or “live play” operation, the incoming or received packet may be placed in the decoder pipeline as well as placing it at the head of the replay queue.

An instant replay request corresponding to a “time shift” of x seconds may be received (step 1104), for example, responsive to user interaction with a GUI element. A corresponding “shifted” position in the replay queue may be determined (step 1106) at least in part by calculating an absolute time point (“replay start timepoint”) of x seconds ago by subtracting x from the current time, and then walking through the queue from the first packet backwards to find the first packet with a timestamp less than the replay start timepoint. The position of that packet in the queue (i.e., the shifted position) becomes the “on deck” packet to be played next (for example, if it is the third packet in the queue, then the on-deck value is 3). When the time shift is greater than 0, the on-deck value may be incremented every time a new packet is received and pushed on to the queue. When the time shift is greater than 0, whenever packet is received and pushed on to the queue, a packet “get” operation may be performed to obtain the packet to be placed in the decoder pipeline. For example, the get operation may decrement the on-deck value and return the packet at the corresponding position in the queue (step 1108). Alternatively, or in addition, the get operation may be triggered by an independent timer.

When a request to return to live playing is received (step 1110), the on-deck value may be reset to zero (step 1112) and incoming packets may again be sent directly to the decoder. For example, the live play request may be received responsive to user interaction with a GUI element. Responsive to the live play request, a stream reset message may be sent (step 1114). For example, the unicast media stream may include sequences of encoded frames that depend on previous frames (e.g., video frames that contain only changes with respect to one or more previous frames) and periodic “key” frames that are independent of previous frames. The stream reset message may instruct the stream encoder to restart encoding with a new key frame. With respect to the requested time shift associated with an instant replay request, there may not be a key frame in the replay queue near the point where the instant replay should start. Consequently, the stream decoder may not be able to decode some number of encoded packets that are passed to it after instant replay starts until it “syncs” to the stream (e.g., encounters a key frame or some sufficient number of non-key frames). In accordance with at least one embodiment of the invention, a “spool up” time interval (e.g., several seconds) may be added to the “time shift” specified by the instant replay request to compensate. As part of step 1108, packets in the spool up interval (and in the replay queue before the queue position determined in step 1106) may be rapidly provided to the stream decoder. In accordance with at least one embodiment of the invention, the additional packets can significantly increase a chance that the stream decoder will be able to decode each of the frames in the requested instant replay window.

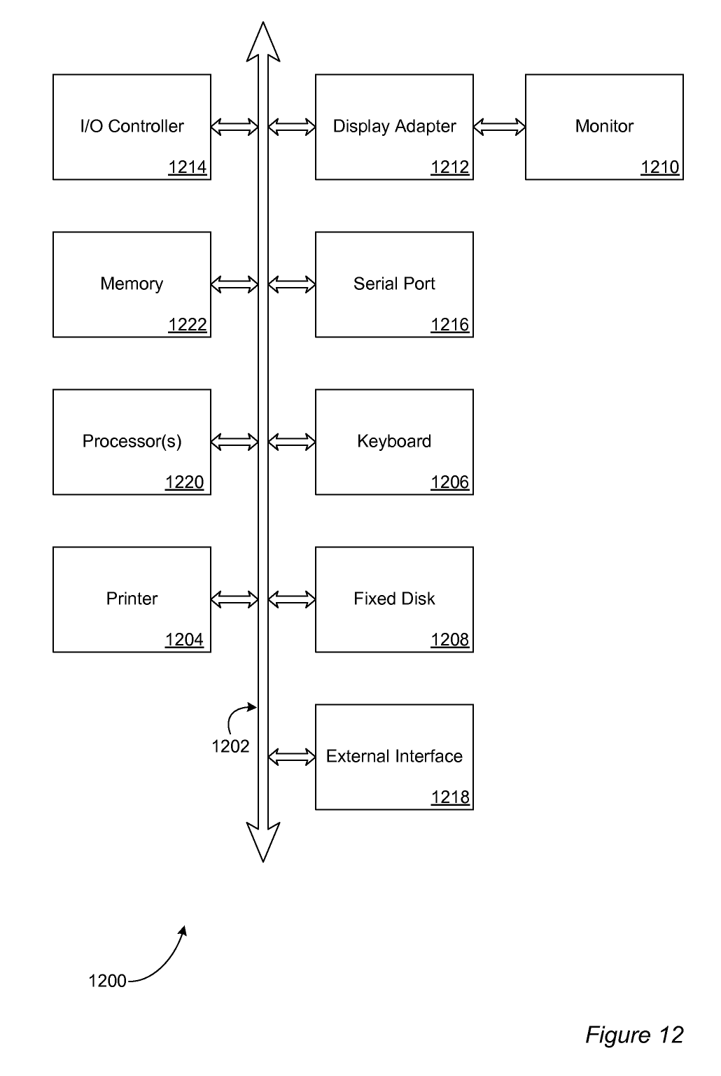

In accordance with at least some embodiments, the system, apparatus, methods, processes and/or operations for communication may be wholly or partially implemented in the form of a set of instructions executed by one or more programmed computer processors such as a central processing unit (CPU) or microprocessor. Such processors may be incorporated in an apparatus, server, client or other computing device operated by, or in communication with, other components of the system. As an example, FIG. 12 depicts aspects of elements that may be present in a computer device and/or system 1200 configured to implement a method and/or process in accordance with some embodiments of the present invention. The subsystems shown in FIG. 12 are interconnected via a system bus 1202. Additional subsystems such as a printer 1204, a keyboard 1206, a fixed disk 1208, a monitor 1210, which is coupled to a display adapter 1212. Peripherals and input/output (I/O) devices, which couple to an I/O controller 1214, can be connected to the computer system by any number of means known in the art, such as a serial port 1216. For example, the serial port 1216 or an external interface 1218 can be utilized to connect the computer device 1200 to further devices and/or systems not shown in FIG. 12 including a wide area network such as the Internet, a mouse input device, and/or a scanner. The interconnection via the system bus 1202 allows one or more processors 1220 to communicate with each subsystem and to control the execution of instructions that may be stored in a system memory 1222 and/or the fixed disk 1208, as well as the exchange of information between subsystems. The system memory 1222 and/or the fixed disk 1208 may embody a tangible computer-readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components, processes or functions described in this application may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

1. A method for concurrent real-time communication, the method comprising:
establishing a communication connection between a first communication device and a second communication device in accordance with a telephony protocol;
maintaining a voice call over the communication connection;
during the voice call, providing for unidirectional streaming of media concurrently captured by the first communication device over the communication connection; and
during the unidirectional streaming of the media, concurrently providing for at least one communicative activity with respect to the media, the at least one communicative activity resulting in communications between the first communication device and at least the second communication device that are at least (i) interactive with the media, (ii) distinct from the media and (iii) related to the media content with respect to communicated information, wherein the at least one communicative activity is configured to modify the media during the unidirectional streaming of the media, wherein a modification is configured to be made to add information associated with a context of the media.

2. The method in accordance with claim 1, wherein the first communication device comprises a device capable of communicating video and audio over a wireless network.

3. The method in accordance with claim 2, wherein the unidirectionally streamed media comprises video captured by a camera of the first communication device.

4. The method in accordance with claim 3, wherein the streaming of the media and the concurrent provision of said at least one communicative activity with respect to the media is controlled at least in part by an application installed on the first communication device by an end-user.

5. The method in accordance with claim 4, wherein said at least one concurrent communicative activity comprises creating a touch-based drawing with respect to the streaming video at the first communication device that is provided for presentation at the second communication device concurrent with the video.

6. The method in accordance with claim 4, wherein said at least one concurrent communicative activity comprises providing a geographical location of the first communication device for presentation at the second communication device.

7. The method in accordance with claim 4, wherein said at least one concurrent communicative activity comprises providing information based at least in part on automated recognition of an object in the streamed video for presentation at the second communication device.

8. The method in accordance with claim 4, wherein said at least one concurrent communicative activity comprises providing information from a contact database maintained by the first communication device for presentation at the second communication device.

9. The method in accordance with claim 4, wherein said at least one concurrent communicative activity comprises concurrently presenting a web page associated with the media at the first communication device and the second communication device.

10. The method in accordance with claim 4, wherein said at least one concurrent communicative activity comprises sending a text message from the first communication device for concurrent presentation with the media at the second communication device.

11. A system for concurrent real-time communication, the system comprising:
a processor; and
a memory storing instructions that, when executed by the processor, cause the system to, at least:
participate in establishing a communication connection between a first communication device and a second communication device in accordance with a telephony protocol;
participate in maintaining a voice call over the communication connection;
participate in providing for unidirectional streaming of media captured by the first communication device over the communication connection concurrent with the voice call; and
participate in providing for at least one communicative activity with respect to the media concurrent with the unidirectional streaming of the media, the at least one communicative activity resulting in communications between the first communication device and at least the second communication device that are at least (i) interactive with the media, (ii) distinct from the media and (iii) related to the media content with respect to communicated information, wherein the at least one communicative activity is configured to modify the media during the unidirectional streaming of the media, wherein a modification is configured to be made to add information associated with a context of the media.

12. The system in accordance with claim 11, wherein the instructions further cause the system to, at least:
terminate the voice call;
subsequent to the termination of the voice call, receive an indication with respect to storing the streamed media for later access; and
cause the streamed media to be stored in accordance with the indication.

13. The system in accordance with claim 11, wherein the instructions further cause the system to, at least:
receive, at the first communication device, a request to present an instant replay of the streamed media; and
cause the instant replay of the streamed media to be presented at the first communication device.

14. The system in accordance with claim 11, wherein the instructions further cause the system to, at least:
cause a user interface of the first communication device to transition to a voice call mode;
while the voice call mode is active, receive a first request to initiate unidirectional streaming of media captured by the first communication device; and
responsive to the first request, cause the use interface of the first communication device to transition to a unicast streaming media mode.

15. The system in accordance with claim 14, wherein the instructions further cause the system to, at least:
while the unicast streaming media mode is active, receive a second request to initiate participation in said at least one communicative activity with respect to the media; and
responsive to the second request, cause the user interface of the first communication device to transition to a media contextualized activity sharing mode.

16. The system in accordance with claim 15, wherein the instructions further cause the system to, at least:
while the media contextualized activity sharing mode is active, receive a third request to terminate participation in said at least one communicative activity; and
responsive to the third request, cause the user interface of the first communication device to transition to the unicast streaming media mode.

17. The system in accordance with claim 16, wherein the instructions further cause the system to, at least:
while the unicast streaming media mode is active, receive a fourth request to terminate unidirectional streaming of media captured by the first communication device; and
responsive to the fourth request, cause the user interface of the first communication device to transition to the voice call mode.

18. At least one non-transitory computer-readable medium having stored thereon computer-executable instructions that configure one or more computer to collectively, at least:
participate in establishing a communication connection between a first communication device and a second communication device in accordance with a telephony protocol;
participate in maintaining a voice call over the communication connection;
participate in providing for unidirectional streaming of media concurrently captured by a first communication device over the communication connection during the voice call; and
participate in providing for at least one concurrent communicative activity with respect to the media during the unidirectional streaming of the media, the at least one communicative activity resulting in communications between the first communication device and at least the second communication device that are at least (i) interactive with the media, (ii) distinct from the media and (iii) related to the media content with respect to communicated information, wherein the at least one communicative activity is configured to modify the media during the unidirectional streaming of the media, wherein a modification is configured to be made to add information associated with a context of the media.

19. The at least one computer-readable medium in accordance with claim 18, wherein providing for unidirectional streaming of media concurrently captured by the first communication device comprises encoding video with a special-purpose processor of the first communication device or an equivalent set of computer-executable instructions.

20. The at least one computer-readable medium in accordance with claim 19, wherein:
the unidirectional streaming of media is provided at least in part by an application installed on the first communication device by an end-user;
an operating system of the first communication device has at least indirect access to the special-purpose processor capable of encoding the video or the equivalent set of computer-executable instructions and provides to installed applications a programmatic object having an interface element capable of creating a file that includes video encoded with the special-purpose processor or the equivalent set of computer-executable instructions; and
providing for unidirectional streaming of media comprises generating a media stream based at least in part on files created by instances of the programmatic object.

21. The at least one computer-readable medium in accordance with claim 20, wherein generating the media stream comprises maintaining an array of instances of the programmatic object.

22. The at least one computer-readable medium in accordance with claim 20, wherein generating the media stream comprises:
extracting video frames from the files created by the instances of the programmatic object; and
determining timestamps for the video frames with respect to a start of the unidirectional streaming of media by the first communication device.

23. The at least one computer-readable medium in accordance with claim 20, wherein encoding the video without the special-purpose processor or the equivalent set of computer-executable instructions would exceed a power budget of the installed application.

24. A method for concurrent real-time communication, the method comprising:
establishing a communication connection between a first communication device and a second communication device in accordance with a telephony protocol;
maintaining a voice call over the communication connection;
during the voice call, presenting, with a display surface of the first communication device, a first graphical user interface having a plurality of interface elements including a first unidirectional media streaming element and a communicative activity element;
responsive to user interaction with the first unidirectional media streaming element, at least:
providing for unidirectional streaming of first media over the communication connection, the first media being captured and streamed concurrent with the voice call; and
presenting, with a display surface of the second communication device, a second graphical user interface having a plurality of interface elements including a second unidirectional media streaming element; and
responsive to user interaction with the communicative activity element, at least providing for at least one communicative activity with respect to the first media, the at least one communicative activity resulting in communications between the first communication device and at least the second communication device that are at least (i) interactive with the first media, (ii) distinct from the first media and (iii) related to the first media content with respect to communicated information, wherein the at least one communicative activity is configured to modify the media during the unidirectional streaming of the first media, wherein a modification is configured to be made to add information associated with a context of the media.

25. The method in accordance with claim 24, wherein:
the plurality of interface elements of the first graphical user interface includes a first media presentation element configured at least to present the first media; and
the plurality of interface elements of a second graphical user interface includes a second media presentation element configured at least to present the first media.

26. The method in accordance with claim 25, further comprising:
responsive to user interaction with the second unidirectional media streaming element,
providing for unidirectional streaming of second media over the communication connection, the second media being captured by the second communication device and streamed concurrent with the voice call; and
presenting the second media with the first media presentation element and the second media presentation element.

27. The method in accordance with claim 26, further comprising:
further in response to the user interaction with the second unidirectional media streaming element, stopping the streaming of the first media before starting the streaming of the second media.

28. The method in accordance with claim 25, further comprising:
responsive to user interaction with a streaming media instant replay element of the second graphical user interface, presenting a previously presented portion of the first media with the second media presentation element.

29. The method in accordance with claim 24, wherein the first graphical user interface comprises a sharing control element enabling control over later sharing of the first media by a recipient to one of more further recipients and subsequent to the original streaming of the first media.

30. The method in accordance with claim 24, wherein the first graphical user interface comprises a communicative activity element that, responsive to user interaction, initiates a communicative activity concurrent with the voice call.

31. The method in accordance with claim 1, wherein said at least one concurrent communicative activity at least enhances an information content of the media.

32. The method in accordance with claim 1, wherein said at least one concurrent communicative activity comprises an information content that is enhanced by the media.
